(19) United States
(12) Patent Application Publication
(10) Pub. No.: US 2026/0012912 A1
(43) Pub. Date: Jan. 8, 2026

(54) METHOD AND APPARATUS FOR PROCESSING INFORMATION, COMMUNICATION DEVICE, AND STORAGE MEDIUM

(71) Applicant: Beijing Xiaomi Mobile Software Co., Ltd., Beijing (CN)

(72) Inventors: Yuxin MAO, Beijing (CN); Jinhua WU, Beijing (CN); Yang SHEN, Beijing (CN)

(73) Assignee: Beijing Xiaomi Mobile Software Co., Ltd., Beijing (CN)

(21) Appl. No.: 18/992,552

(22) PCT Filed: Jul. 11, 2022
(86) PCT No.: PCT/CN2022/105007

§ 371 Date: Jan. 8, 2025

(51) Int. Cl. H04W 60/00; H04B 7/185

(52) U.S. Cl. CPC H04W 60/00; H04B 7/18513

(57) ABSTRACT

A method for processing information, the method includes: a first core network device receiving a terrestrial network (TN) cell identifier transmitted by a second core network device or a TN access network device, where the TN cell identifier: indicates a location of user equipment (UE), identification information of a cell used by the UE in a case of access through a TN, and is configured for the first core network device to perform location verification on the UE when accessing through a non-terrestrial network (NTN).

### CROSS-REFERENCE TO RELATED APPLICATIONS

The present application is a U.S. National Stage of International Application No. PCT/CN2022/105007, filed on Jul. 11, 2022, the contents of all of which are incorporated herein by reference in their entireties for all purposes.

### BACKGROUND OF THE INVENTION

Non-terrestrial networks (NTNs), a type of communication networks relative to traditional terrestrial networks (TNs), utilize satellites or airborne vehicles to provide communication services to user equipment (UE).

### SUMMARY OF THE INVENTION

Examples of the disclosure provide a method and apparatus for processing information, a communication device, and a storage medium.

A method for processing information is provided. The method is performed by a first core network device and includes: receiving a terrestrial network (TN) cell identifier transmitted by a second core network device or a TN access network device, where the TN cell identifier: indicates a location of user equipment (UE), identification information of a cell used by the UE when accessing through a TN, and is configured for the first core network device to perform location verification on the UE when accessing through a non-terrestrial network (NTN).

A method for processing information is provided. The method is performed by a second core network device and includes: receiving a second registration request message sent by UE through a terrestrial network (TN) access network device, where the second registration request message includes location verification indicating information in the circumstance of NTN access; and obtaining, from a third core network device, an identifier of a first core network device selected by the UE when accessing through the NTN according to the location verification indicating information in the circumstance of the NTN access, where the identifier of the first core network device is configured for the second core network device or the TN access network device to transmit a TN cell identifier used by the UE to the first core network device, and the TN cell identifier is configured for the first core network device to perform location verification on the UE when accessing through the NTN.

A method for processing information is provided. The method is performed by a TN access network device and includes: receiving, from a second core network device, an identifier of a first core network device selected by UE when accessing through an NTN; and transmitting a TN cell identifier used by the UE to the first core network device according to the identifier of the first core network device, where the TN cell identifier is configured for the first core network device to perform location verification on the UE when accessing through the NTN.

A communication device is provided. The communication device includes: one or more processors, and a memory configured to store processor-executable instructions, where the one or more processors are collectively configured to implement the method for processing information when running the executable instructions.

A non-transitory computer-readable storage medium is provided. The non-transitory computer-readable storage medium stores a computer-executable program. The executable program when executed by a processor, implements the method for processing information.

It can be understood that the foregoing general description and the following detailed description are illustrative and explanatory merely and do not limit the examples of the disclosure.

### BRIEF DESCRIPTION OF DRAWINGS

The accompanying drawings here are incorporated in the description as a constituent part of the description, illustrate examples conforming to the disclosure, and serve to explain the principles in the examples of the disclosure along with the description.

FIG. 1 is a schematic structural diagram of a radio communication system according to an example.

FIG. 2 is a schematic flowchart of a method for processing information according to an example.

FIG. 3 is a schematic flowchart of a method for processing information according to an example.

FIG. 4 is a schematic flowchart of a method for processing information according to an example.

FIG. 5 is a schematic flowchart of a method for processing information according to an example.

FIG. 6 is a schematic structural diagram of a terrestrial network (TN) cell identifier according to an example.

FIG. 7 is a schematic structural diagram of an apparatus for processing information according to an example.

FIG. 8 is a schematic structural diagram of an apparatus for processing information according to an example.

FIG. 9 is a schematic structural diagram of an apparatus for processing information according to an example.

FIG. 10 is a schematic structural diagram of user equipment (UE) according to an example.

FIG. 11 is a schematic structural diagram of a communication device according to an example.

### DETAILED DESCRIPTION OF THE INVENTION

Description will be made in detail to examples here, and their instances are illustrated in the accompanying drawings. When the following description relates to the accompanying drawings, the same numbers in different accompanying drawings denote the same or similar elements, unless indicated otherwise. The embodiments described in the examples below do not denote all embodiments consistent with the examples of the disclosure. Rather, they are merely instances of apparatus and methods consistent with some aspects of the examples of the disclosure.

The terms used in the examples of the disclosure are merely used to describe specific examples, rather than limit the examples of the disclosure. As used in the disclosure, singular forms “a”, “an” and “the” are intended to include plural forms as well, unless otherwise indicated in the context clearly. It can also be understood that the term “and/or” as used here refers to and encompasses any or all possible combinations of one or more of associated items listed.

It can be understood that although the terms of first, second, third, etc. may be used in the examples of the disclosure to describe various information, such information cannot be limited to these terms. These terms are merely used to distinguish between the same type of information. For example, first information can also be referred to as second information, and similarly, second information can also be referred to as first information, without departing from the scope of the examples of the disclosure. The word “if” as used here can be interpreted as “at the time of”, “when”, or “in response to determining”, depending on the context.

The network structure and service cases described in the example of the disclosure are intended to describe the technical solutions of the examples of the disclosure more clearly, instead of limiting the technical solutions provided in the examples of the disclosure. As those of ordinary skill in the art know, with evolution of the network structure and emergence of new business cases, the technical solutions provided in the examples of the disclosure are also applicable to similar technical problems.

The present disclosure relates to, but is not limited to, the technical field of radio communication, and in particular relates to a method and apparatus for processing information, a communication device, and a storage medium.

FIG. 1 is a schematic structural diagram of a radio communication system according to an example. To facilitate understanding of the examples of the disclosure, first, a radio communication system applicable to the examples of the disclosure will be described in detail with a radio communication system shown in FIG. 1 as an instance. It can be pointed out that the solutions in the examples of the disclosure may also be performed to other radio communication systems. Corresponding names may also be replaced with names of corresponding functions in other radio communication systems.

As shown in FIG. 1, the radio communication system is a communication system based on a cellular mobile communication. The radio communication system may include: several pieces of user equipment 11, several network devices 12 and a network management device 13.

Each piece of user equipment 11 may be a device providing voice and/or data connectivity for a user. The user equipment 11 may communicate with one or more core networks via a radio access network (RAN). The user equipment 11 may be an Internet of Things user device, such as a sensor device, a mobile phone (or referred to as a “cellular” phone), and a computer having an Internet of Things user device, for example, a stationary, portable, pocket, handheld, intra-computer, or vehicle-mounted apparatus. For example, the user equipment 11 may be a station (STA), a subscriber unit, a subscriber station, a mobile station, a mobile, a remote station, an access point, a remote terminal, an access terminal, a user terminal, a user agent, a user device, or user equipment. Alternatively, the user equipment 11 may be a wearable device, a virtual reality (VR) device, an augmented reality (AR) device, or a VR/AR hybrid headset. Alternatively, the user equipment 11 may be a device of an unmanned aerial vehicle. Alternatively, the user equipment 11 may be an in-vehicle device, for example, an electronic control unit with a radio communication function, or a radio user device to which an electronic control unit is externally connected. Alternatively, the user equipment 11 may be a roadside device, for example, a street lamp, a signal lamp, another roadside device, etc. with the radio communication function.

Each network device 12 may be a non-terrestrial network (NTN) device having all or some of the functions of an access network device, or may be an access network device on the ground.

A device, such as the satellite or the airborne vehicle, in an NTN deployed in the air can be called an NTN device. For example, the NTN device may be any one of a satellite, a high altitude platform system (HAPS), and an air to ground (ATG) device. The NTN includes two transmission types of transparent transmission and non-transparent transmission (non-transparent transmission is also called “regenerative transmission”). In a transparent NTN, only frequency conversion and signal amplification are performed on an NTN device, that is, the NTN device is a relay device between a terminal device and an access network device. In a non-transparent NTN, an NTN device has some or all of functions of an access network device.

The access network device is an entity, such as a generation Node B (gNodeB), configured to transmit or receive a signal on a network side. The access network device may be a device for communicating with a mobile device. The network device may be configured to convert received air frames to and from Internet protocol (IP) packets, and act as a router between a radio terminal and the rest of the access network, where the rest of the access network may include an Internet protocol (IP) network. The network device may also coordinate attribute management for an air interface. The radio communication system may be a 4th generation mobile communication (4G) system, which is also referred to as a long term evolution (LTE) system. Alternatively, the radio communication system may also be a 5th generation mobile communication (5G) system, which is also referred to as a new radio (NR) system or a 5G NR system. Alternatively, the radio communication system may also be a next generation system of the 5G system. An access network in the 5G system may be referred to as a new generation-radio access network (NG-RAN).

The network device 12 may be an evolved node B (eNB) used in the 4G system. Alternatively, the network device 12 may also be an access device using a central-distributed architecture in the 5G (gNB) system. When using the central-distributed architecture, the network device 12 typically includes a central unit (CU) and at least two distributed units (DUs). The central unit is provided with a protocol stack of a packet data convergence protocol (PDCP) layer, a radio link control (RLC) layer, and a media access control (MAC) layer. Each distributed unit is provided with a protocol stack of a physical (PHY) layer. Particular embodiments of the network device 12 are not limited in the examples of the disclosure.

The network devices 12 may be in radio connection to the user equipment 11 through a wireless air interface. In different embodiments, the wireless air interface is a wireless air interface based on a standard of the 4th generation mobile communication (4G) or a standard of the 5th generation mobile communication (5G), and is a new radio, for example. Alternatively, the wireless radio may also be a wireless air interface based on a standard of the next generation mobile communication of the 5G.

In an example, an end to end (E2E) connection or a device to device (D2D) connection may also be established between the user equipment 11, For example, scenarios such as vehicle to vehicle (V2V) communication, vehicle to infrastructure (V2I) communication, and vehicle to pedestrian (V2P) communication in vehicle to everything (V2X) communication are provided.

In an example, the network devices 12 may be located in a communication system that is converged with a satellite communication system and may provide connectivity services to a satellite, and connect the satellite to a core network. For example, each network device 12 may be an access network device having a satellite gateway function in the communication system, such as a gateway device, a ground station device, and a non-terrestrial networks gateway (NTN-Gateway).

In an example, the radio communication system above may further encompass a network management device 13. The several network devices 12 are connected to the network management device 13 separately.

In an example, the network management device 13 may be a core network device in the radio communication system. For example, the core network device 13 may be a mobility management entity (MME) in an evolved packet core (EPC). Alternatively, the core network device may also be a serving gateway (SGW), a public data network gateway (PGW), a policy and charging rules function (PCRF), a home subscriber server (HSS), etc. The examples of the disclosure do not limit an implementation form of the core network device 13.

In an example, the network management device 13 may be an access and mobility management function (AMF), unified data management (UDM), a session management function (SMF), a user plane function (UPF), etc. The examples of the disclosure do not limit an implementation form of the network management device 13.

The AMF, the UDM, etc. in the example of the disclosure may be implemented by one entity device, or may be jointly implemented by a plurality of entity devices. It can be understood that the AMF, the UDM, etc. in the example of the disclosure may be a logical function module in an entity device, or may be a logical function module composed of a plurality of entity devices, which is not limited in the example of the disclosure.

In order to facilitate understanding by those skilled in the art, the examples of the disclosure enumerate a plurality of embodiments to clearly describe the technical solutions of the examples of the disclosure. Certainly, those skilled in the art may understand that the plurality of examples provided in the examples of the disclosure may be executed independently, may be executed together with the methods of other examples in the examples of the disclosure, or may be executed together with some methods of other related arts independently or in combination, which are not limited in the examples of the disclosure.

Non-terrestrial networks (NTNs), a type of communication networks, utilize satellites or airborne vehicles to provide communication services to user equipment based on terrestrial networks. A device, such as the satellite or the airborne vehicle, in an NTN deployed in the air can be called an NTN device. For example, the NTN device may be any one of a satellite, a high altitude platform system (HAPS), and an air to ground (ATG) device. The NTN includes two transmission types of transparent transmission and non-transparent transmission (non-transparent transmission is also called “regenerative transmission”). In a transparent NTN, only frequency conversion and signal amplification are performed on an NTN device, that is, the NTN device is a relay device between a terminal device and an access network device. In a non-transparent NTN, an NTN device has some or all of functions of an access network device.

For example, in satellite communication, when the UE accesses a network (for example, a 5G network) through an NTN, the network needs to perform location verification on a user in order to verify whether the user is allowed to access a public land mobile network (PLMN) selected by the UE at its current location in view of the needs for information security, device management and/or regulatory supervision. For example, with large coverage, one satellite cell may cover areas of both country A and country B (typically, the satellite cell covers the area of the two countries at a border of the two countries). Network operators of the two countries may share a satellite for access, while regulations of country B require that users in other countries are prohibited from accessing the national operator network in a non-roaming manner. In this case, if a user in country A located in the border area selected to access a network of country B through the satellite access, a network device (for example, an AMF) of the operator in country B verifies a location of the user and determines whether the user is located in country B. if not, the user is prohibited from using the network of country B by means of direct access (in a non-roaming manner).

In the related art, when the UE accesses a network through the NTN, a base station device (for example, gNB) reports a tracking area identity (TAI) representing a current location of the UE to a network device (for example, AMF). The AMF performs location verification on the UE based on the TAI. The TAI may be based on location information reported by the UE. The location information may be obtained through a global navigation satellite system (GNSS) or an assisted global navigation satellite system (A-GNSS, also referred to as network augmented satellite positioning system). However, it is unreliable that the TAI representing the location the UE is generated according to any location information generated by the UE, that is, there is a possibility that the UE transmits a fake location. In view of requirements of information security, device management and/or regulatory supervision, an obtained UE location needs to be guaranteed to be credible for a process of UE location verification.

For ease of understanding of functions by those skilled in the art, some terms in the examples of the disclosure are explained below.

First core network device is a core network device selected by UE when accessing through an NTN.

Second core network device is a core network device selected by UE when accessing through a TN.

Both the first core network device and the second core network device may be mobility management network elements which are control plane network elements provided by an operator network, may be configured for access control and mobility management when UE accesses an operator network, and have functions such as mobility state management, user temporary identity allocation, authentication and user authorization. In a 5G network, the mobility management network element may be an AMF. In future communications such as the 6th generation (6G), the mobility management network element may still be an AMF or have other names, which is not limited in the disclosure.

NTN access network device is an access network device of an NTN, where the NTN access network device may be an NTN device having all or some functions of an access network device, or an access network device connected to an NTN device.

TN access network device is an access network device of a terrestrial network.

Third core network device may be UDM for providing management of some control plane data (for example, data that may be shared by a plurality of network functions (NFs)) and providing a way for requesting data, storing data, and updating data to the NFs.

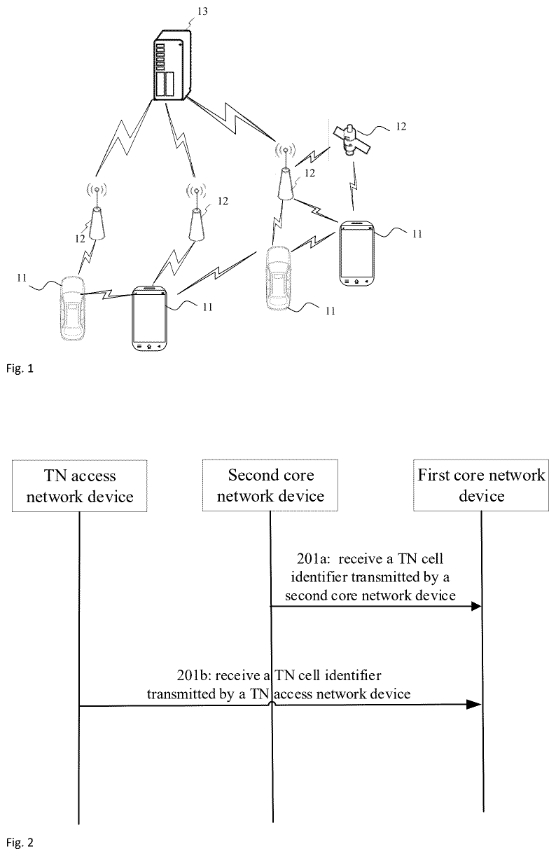

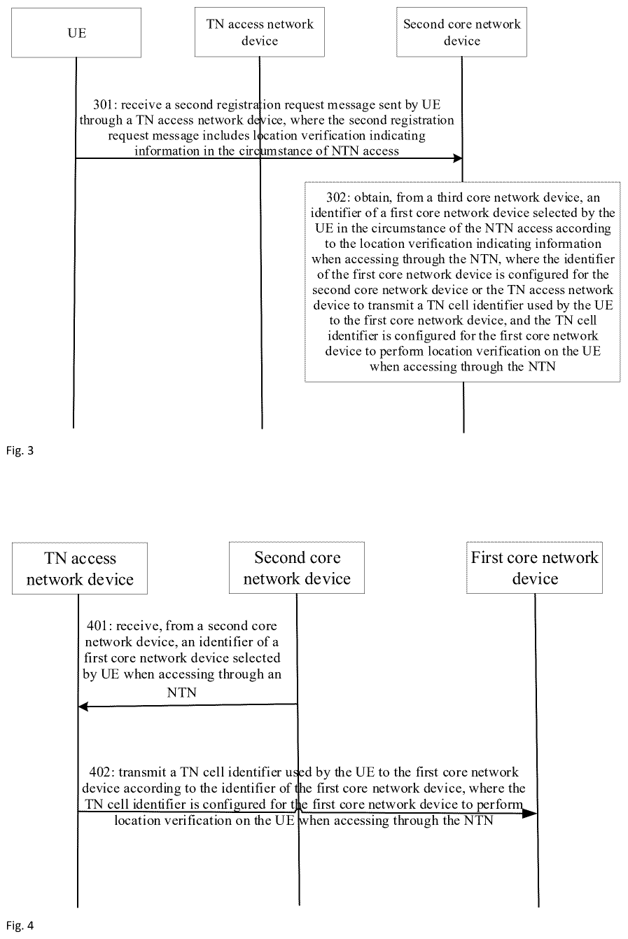

FIG. 2 is a flowchart of a method for processing information according to an example. The method for processing information is performed by a first core network device. As shown in FIG. 2, the method for processing information may include at least steps 201a or 201b.

Step 201a: a TN cell identifier transmitted by a second core network device is received.

Alternatively, in step 201b: a TN cell identifier transmitted by a TN access network device is received.

The TN cell identifier: indicates a location of user equipment (UE), identification information of a cell used by the UE when accessing through a TN, and is configured for the first core network device to perform location verification on the UE when accessing through an NTN.

The UE may be a mobile phone terminal that uses a cellular mobile communication network technology for radio communication. The UE has a capability of supporting access through the TN and the NTN. A location area where the UE is currently located is covered by the access through the TN and the NTN.

In some instances, the TN cell identifier is configured to indicate the location of the UE, and may be a cell global identifier (CGI) of the cell used by the UE when accessing through the TN. The CGI may be configured to identify an area covered by a cell.

In some instances, the TN cell identifier may be transmitted by the TN access network device to the second core network device in a process of access by the UE through the TN, and transmitted by the second core network device to the first core network device.

In some instances, the TN cell identifier may be transmitted by the second core network device to the first core network device according to the identifier of the first core network device.

In some instances, the identifier of the first core network device may include at least one of an Internet Protocol (IP) address, a domain name identifier, or a host name. It can be understood that as long as the identifier of the first core network device can be configured to address the first core network device, the example does not limit a specific type of the identifier of the first core network device.

Illustratively, the identifier of the first core network device may be obtained by the second core network device from a third core network device (for example, UDM). The identifier of the first core network device pre-stored by the third core network device may be stored in the third core network device by the first core network device after the first core network device processes the first registration request message sent by the UE when accessing through the NTN.

In some instances, the identifier of the first core network device and an NTN access type used by the UE may be transmitted to the third core network device (for example, UDM) by the first core network device, such that the identifier of the first core network device stored in the third core network device may be obtained from the third core network device by the second core network device.

In some instances, the TN cell identifier may be carried in a notification message transmitted by the second core network device to the first core network device.

The TN cell identifier used by the UE when accessing through the TN may be read by the first core network device from the notification message transmitted by the second core network device.

In some instances, the TN cell identifier is transmitted by the TN access network device to the first core network device according to the identifier of the first core network device.

The identifier of the first core network device may be obtained by the second core network device from the third core network device (for example, UDM) and transmitted by the second core network device to the TN access network device.

In some instances, the TN cell identifier may be carried in a registration request message sent by the TN access network device to the first core network device.

The TN cell identifier used by the UE when accessing through the TN may be read by the first core network device from the registration request message sent by the TN access network device.

According to the method for processing information provided in the example of the disclosure, the TN cell identifier transmitted by the second core network device or the TN access network device is received by the first core network device. The TN cell identifier is configured for the first core network device to perform location verification on the UE when accessing through the NTN. Due to limitation of coverage of a TN cell, the TN cell identifier, as identification information of a cell used by the UE when accessing through the TN, can accurately represent the location of the UE. Thus, compared with a TAI representing the location of the UE, the TN cell identifier has higher reliability, and can improve reliability of the location verification of the UE in an NTN access scenario.

In some examples, the TN cell identifier transmitted by the second core network device or the terrestrial network (TN) access network device may be received include: the TN cell identifier transmitted by the second core network device or the TN access network device and a time stamp related to the TN cell identifier are received.

The time stamp related to the TN cell identifier may reflect whether the TN cell identifier transmitted to the first core network device is reliable. If time recorded by the time stamp is closer to current time, it indicates that the location of the UE represented by the TN cell identifier is closer to a current real location of the UE, and reliability of the location verification performed by the first core network device on the UE when accessing through the NTN is higher.

In an example, the first core network device is selected by an NTN access network device when accessing by the UE through the NTN; and the second core network device is selected by the TN access network device when accessing by the UE through the TN.

In a process that the UE accesses a network through the NTN, before the first registration request message of the UE is forwarded to the core network device by the NTN access network device, the NTN access network device selects a corresponding core network device, that is, selects the first core network device for processing the first registration request message.

For example, when accessing by the UE through the NTN, the NTN access network device may select the first core network device based on local configuration or network slicing.

In a process that the UE accesses a network through the TN, before a second registration request message of the UE is forwarded to the core network device by the TN access network device, the TN access network device selects a corresponding core network device, that is, selects the second core network device for processing the second registration request message.

For example, when accessing by the UE through the TN, the TN access network device may select the second core network device based on local configuration or network slicing.

In an example, the method may further include: in a case that a registration request message carrying the TN cell identifier and sent by the TN access network device is received, a registration reject message (registration reject) to deny the UE access through a TN access network is transmitted to the UE.

The registration reject message may include a cause value of denying access by the UE through the TN access network.

In the example, when the UE accesses a network through the NTN, in order to obtain the UE location information with high reliability, the first core network device may instruct the UE to perform access through the TN, so as to obtain identifier information of the TN cell (that is, TN cell identifier) used by the UE when accessing through the TN. After the TN cell identifier transmitted by the TN access network device is received, a registration reject message to deny network the UE access through the TN is transmitted to the UE by the first core network device.

In an example, the location verification on the UE when accessing through the non-terrestrial network (NTN) may include: based on location information of the UE corresponding to the TN cell identifier, whether the UE is allowed to access a PLMN selected by the UE at the location of the UE is verified; and in a case that the UE is not allowed to access the PLMN selected by the UE at the location of the UE, a de-registration message of access through the NTN is transmitted to the UE.

When the first core network device verifies that the UE is not allowed to access the PLMN selected by the UE at the location of the UE, a de-registration procedure is initiated to the UE. For example, a de-registration request message is transmitted to the UE by the first core network device. The de-registration message may carry at least one piece of indication information. The indication information may be configured to indicate to the UE that the location verification fails. For example, the indication information may indicate that the UE is not allowed to access the PLMN at the current location.

In an example, the method may further include: if it is verified that the UE is allowed to access the PLMN selected by the UE at the UE location, a location verification procedure is ended.

In an example, the method may further include: a registration response message is returned to the UE according to a first registration request message sent by the UE through the NTN access, where the registration response message comprises location verification indicating information in the circumstance of the NTN access, and the location verification indicating information is configured to request the location information of the UE when accessing through the TN.

The first registration request message includes an identifier of the UE, and further includes information such as a registration type of the current registration and capabilities of the UE. The identifier of the UE may include any one or more of the following: a subscription concealed identifier (SUCI), a globally unique temporary UE identity (GUTI), a generic public subscription identifier (GPSI), a subscriber permanent identifier (SUPI), etc.

Specifically, after the first registration request message sent by the UE through the NTN access, the first registration request message is processed by the first core network device, and a registration response message is returned to the UE. Location verification indicating information is carried in the registration response message.

In a process that the UE accesses a network through the NTN, a first registration request message may be sent by the UE to the NTN access network device. After the first registration request message of the UE is received, the first registration request message is forwarded to the selected first core network device by the NTN access network device. After registration of the UE is completed, a registration accept message is returned to the UE by the first core network device. The registration accept message may carry the location verification indicating information.

In some instances, the TN cell identifier may be transmitted by the second core network device to the first core network device according to location verification information carried in the second registration request message sent by the UE when accessing through the TN.

For example, in a process that the UE accesses a network through the TN, a second registration request may be transmitted to the TN access network device by the UE. The second registration request includes the location verification indicating information. After the second registration request message of the UE is received, the cell identifier of the TN cell used by the UE when accessing through the TN may be reported to the selected second core network device by the TN access network device when the second registration request message is forwarded. The second core network device may obtain the identifier of the first core network device according to the location verification information, and transmit the TN cell identifier to the first core network device according to the identifier of the first core network device.

In some instances, the TN cell identifier may be transmitted to the first core network device according to the identifier of the first core network device that is obtained by the TN access network device from the selected second core network device according to the location verification information carried in the second registration request message sent by the UE when accessing through the TN.

For example, in a process that the UE accesses a network through the TN, a second registration request message may be sent to the TN access network device by the UE. The second registration request message includes the location verification indicating information. After the second registration request message of the UE is received, the second registration request message is forwarded to the selected second core network device by the TN access network device, and the identifier of the first core network device returned by the second core network device according to the location verification indicating information in the second registration request message is obtained. The cell identifier of the TN cell used by the UE when accessing through the TN is transmitted to the first core network device according to the identifier of the first core network device by the TN access network device.

In some instances, the TN cell identifier and the identifier of the first core network device may be transmitted to the TN access network device through the second core network device, and the TN cell identifier may be transmitted to the first core network device according to the identifier of the first core network device by the TN access network device.

For example, in a process that the UE accesses a network through the TN, a second registration request message may be transmitted to the TN access network device by the UE. The second registration request message includes the location verification indicating information. After the second registration request message of the UE is received, the TN cell identifier of the TN cell used by the UE when accessing through the TN may be reported to the selected second core network device by the TN access network device when the second registration request message is forwarded. The second core network device may obtain the identifier of the first core network device according to the location verification information, and transmit the identifier of the first core network device and the TN cell identifier to the TN access network device. The TN cell identifier is transmitted to the first core network device according to the identifier of the first core network device by the TN access network device.

In an example, the method further includes: an identifier of the first core network device is transmitted to a third core network device, where the identifier of the first core network device is configured to be stored in the third core network device.

The third core network device may be UDM.

In the example, after the first registration request message sent by the UE when accessing through the TN is processed, the identifier of the first core network device and the NTN access type used by the UE may be transmitted to the third core network device by the first core network device, such that the identifier of the first core network device and the NTN access type used by the UE are stored in the third core network device.

FIG. 3 is a flowchart of a method for processing information according to an example. As shown in FIG. 3, the method for processing information is performed by a second core network device. The method may include at least steps 301 and 302.

Step 301: a second registration request message sent by UE through a TN access network device is received, where the second registration request message includes location verification indicating information in the circumstance of NTN access.

Step 302: an identifier of a first core network device selected by the UE when accessing through the NTN is obtained from a third core network device according to the location verification indicating information in the circumstance of the NTN access, where the identifier of the first core network device is configured for the second core network device or the TN access network device to transmit a TN cell identifier used by the UE to the first core network device, and the TN cell identifier is configured for the first core network device to perform location verification on the UE when accessing through the NTN.

The UE may be a mobile phone terminal that uses a cellular mobile communication network technology for radio communication. The UE has a capability of supporting access through the TN and the NTN. A location area where the UE is currently located is covered by the access through the TN and the NTN. The third core network device may be UDM.

In some instances, the location verification indicating information may be carried in a registration response message transmitted by the first core network device to the UE through the NTN access network device. The registration response message is configured to respond to a first registration request message sent by the UE through the NTN access network device.

In some instances, the second registration request message may be sent by the UE to the second core network device through the TN access network device after the registration response message transmitted by the first core network device through the NTN access network device is received.

In some instances, the identifier of the first core network device may include at least one of an Internet Protocol (IP) address, a domain name identifier, or a host name. It can be understood that as long as the identifier of the first core network device can be configured to address the first core network device, the example does not limit a specific type of the identifier of the first core network device.

Illustratively, the identifier of the first core network device may be obtained by the second core network device from the third core network device (for example, UDM). The identifier of the first core network device pre-stored by the third core network device may be transmitted to the third core network device by the first core network device after the first core network device processes the first registration request message sent by the UE when accessing through the NTN.

In some instances, the identifier of the first core network device may be carried in a rerouting message by the second core network device and transmitted to the TN access network device. The rerouting message may be a non-access-stratum (NAS) message.

In some instances, the identifier of the first core network device and an NTN access type used by the UE may be transmitted by the first core network device to the third core network device (for example, UDM).

In some instances, the TN cell identifier may be transmitted by the second core network device to the first core network device according to the identifier of the first core network device.

In some instances, the TN cell identifier is carried in a notification message transmitted by the second core network device to the first core network device.

In some instances, the TN cell identifier may be transmitted by the TN access network device to the first core network device according to the identifier of the first core network device.

The identifier of the first core network device may be obtained by the second core network device from the third core network device (for example, UDM) and transmitted by the second core network device to the TN access network device.

In some instances, the TN cell identifier is carried in a registration request message sent by the TN access network device to the first core network device.

In some instances, the TN cell identifier is configured to indicate the location of the UE, and may be a cell global identifier of the cell used by the UE when accessing through the TN.

In some instances, the TN cell identifier may be transmitted by the TN access network device to the second core network device in a process of access by the UE through the TN.

The example of the disclosure provides a method for processing information. After the second registration request message sent by the UE through the TN access network device is received by the second core network device, the identifier of the first core network device selected by the UE when accessing through the NTN is obtained from the third core network device according to the location verification indicating information when accessing through the NTN contained in the second registration request message. In this way, the TN cell identifier of the TN cell used by the UE may be transmitted to the first core network device according to the identifier of the first core network device by the second core network device or the TN access network device, such that the first core network device can use the TN cell identifier to perform location verification on the UE when accessing through the NTN. Due to limitation of coverage of a TN cell, the TN cell identifier, as identification information of a cell used by the UE when accessing through the TN, can accurately represent the location of the UE. Thus, compared with a TAI representing the location of the UE, the TN cell identifier has higher reliability, and can improve reliability of the location verification of the UE in an NTN access scenario.

In an example, the first core network device is selected by an NTN access network device when accessing by the UE through the NTN; and the second core network device is selected by the TN access network device when accessing by the UE through the TN.

In a process that the UE accesses a network through the NTN, before the first registration request message of the UE is forwarded to the core network device by the NTN access network device, the NTN access network device selects a corresponding core network device, that is, selects the first core network device for processing the first registration request message.

For example, when accessing by the UE through the NTN, the NTN access network device may select the first core network device based on local configuration or network slicing.

In a process that the UE accesses a network through the TN, before a second registration request message of the UE is forwarded to the core network device by the TN access network device, the TN access network device selects a corresponding core network device, that is, selects the second core network device for processing the second registration request message.

For example, when accessing by the UE through the TN, the TN access network device may select the second core network device based on local configuration or network slicing.

In an example, the second registration request message further includes the TN cell identifier used by the UE.

In an example, the method further includes the TN cell identifier is transmitted to the first core network device according to the identifier of the first core network device.

Specifically, the TN cell identifier may be carried in the notification message and transmitted to the first core network device according to the identifier of the first core network device by the second core network device.

In some examples, the method further includes the TN cell identifier and a time stamp related to the TN cell identifier are transmitted to the first core network device according to the identifier of the first core network device.

The time stamp related to the TN cell identifier may reflect whether the TN cell identifier transmitted to the first core network device is reliable. If time recorded by the time stamp is closer to current time, it indicates that the location of the UE represented by the TN cell identifier is closer to a current real location of the UE, and reliability of the location verification performed by the first core network device on the UE when accessing through the NTN is higher.

In an example, the method further includes the identifier of the first core network device is transmitted to the TN access network device.

Specifically, the identifier of the first core network device may be carried in the rerouting message transmitted to the TN access network device by the second core network device.

In the example, the identifier of the first core network device may be transmitted to the TN access network device by the second core network device. A cell identifier indicated by the location verification indicating information is transmitted to the first core network device according to the identifier of the first core network device by the TN access network device.

In an example, the method further includes the TN cell identifier is transmitted to the TN access network device.

Specifically, if the second core network device determines not to transmit the TN cell identifier to the first core network device, the second core network device may transmit the TN cell identifier and the identifier of the first core network device to the TN access network device. The TN cell identifier is transmitted to the first core network device according to the identifier of the first core network device by the TN access network device.

In some examples, the method further includes the TN cell identifier and a time stamp related to the TN cell identifier are transmitted to the TN access network device.

In an example, the method further includes after the TN cell identifier is transmitted to the first core network device, a registration reject message to deny the UE access through a TN access network is transmitted to the UE.

The registration reject message may include a cause value of to deny the UE access through the TN access network.

In the example, when the UE accesses a network through the NTN, in order to obtain the UE location information with high reliability, the first core network device may instruct the UE to perform access through the TN, so as to obtain identifier information of the TN cell (that is, TN cell identifier) used by the UE when accessing through the TN. After the TN cell identifier is transmitted to the first core network device by the second core network device, a registration reject message to deny the UE access through the TN is transmitted to the UE by the second core network device.

FIG. 4 is a flowchart of a method for processing information according to an example. As shown in FIG. 4, the method for processing information is performed by a terrestrial network (TN) access network device. The method may include at least steps 401 and 402.

Step 401: an identifier of a first core network device selected by UE through an NTN is received from a second core network device.

Step 402: a TN cell identifier used by the UE is transmitted to the first core network device according to the identifier of the first core network device, where the TN cell identifier is configured for the first core network device to perform location verification on the UE when accessing through the NTN.

The UE may be a mobile phone terminal that uses a cellular mobile communication network technology for radio communication. The UE has a capability of supporting access through the TN and the NTN. A location area where the UE is currently located is covered by the access through the TN and the NTN.

In some instances, the identifier of the first core network device may be carried in a rerouting message transmitted by the second core network device to a TN access network device.

In some instances, the identifier of the first core network device may include at least one of an Internet Protocol (IP) address, a domain name identifier, or a host name. It can be understood that as long as the identifier of the first core network device can be configured to address the first core network device, the example does not limit a specific type of the identifier of the first core network device.

Illustratively, the identifier of the first core network device may be obtained by the second core network device from a third core network device (for example, UDM) and transmitted by the second core network device to the TN access network device. The identifier of the first core network device pre-stored by the third core network device may be transmitted to the third core network device by the first core network device after the first core network device processes the first registration request message sent by the UE when accessing through the NTN.

In some instances, the TN cell identifier is carried in a registration request message sent by the TN access network device to the first core network device.

In some instances, the TN cell identifier is configured to indicate the location of the UE, and may be a cell global identifier of the cell used by the UE when accessing through the TN.

In some instances, the TN cell identifier may be determined by the TN access network device after a second registration request message sent by the UE when accessing through the TN is received.

The second registration request message includes location verification indicating information in the circumstance of the NTN access. The location verification indicating information is configured to request location information of the UE when accessing through the TN.

In some instances, the second registration request message may be sent by the UE to the TN access network device after the registration response message transmitted by the first core network device through the NTN access network device is received. The location verification indicating information is carried in the registration response message.

The example of the disclosure provides a method for processing information. The TN access network device receives the identifier of the first core network device selected by the UE when accessing through the NTN from the second core network device, and transmits the TN cell identifier used by the UE to the first core network device according to the identifier of the first core network device, such that the first core network device can use the TN cell identifier to perform location verification on the UE when accessing through the NTN. Due to limitation of coverage of a TN cell, the TN cell identifier, as identification information of a cell used by the UE when accessing through the TN, can accurately represent the location of the UE. Thus, compared with a TAI representing the location of the UE, the TN cell identifier has higher reliability, and can improve reliability of the location verification of the UE in an NTN access scenario.

In an example, the method further includes the TN cell identifier is received from the second core network device.

Specifically, if the second core network device determines not to transmit the TN cell identifier to the first core network device, the second core network device may transmit the TN cell identifier and the identifier of the first core network device to the TN access network device. The TN cell identifier is transmitted to the first core network device according to the identifier of the first core network device by the TN access network device.

In an example, the method further includes the TN cell identifier and a time stamp related to the TN cell identifier are received from the second core network device.

In an example, the TN cell identifier is carried in a registration request message sent to the first core network device.

Specifically, the TN cell identifier may be carried in the registration request message and sent to the first core network device according to the identifier of the first core network device by the TN access network device.

Specific examples are provided in order to further describe the example of the disclosure.

The UE in the example of the disclosure has a capability of supporting access through the TN and access through the NTN. A location area where the UE is currently located covers access through the TN and access through the NTN.

In order to effectively implement location verification on the UE when accessing through the NTN, the disclosure reports location information of the UE to a location verification network element (that is, the first core network device in the above example) when accessing by the UE through the TN. Since the UE reports a cell identifier (CGI) in a process of accessing a network (whether through the TN or the NTN), the CGI includes the location information. The location information included in the cell identifier corresponding to the TN cell selected by the UE may represent information of a location where the UE is currently located.

As shown in FIG. 5, the TN cell identifier is the CGI, and its structure consists of a mobile country code (MCC), a mobile network code (MNC), a location area code (LAC) and a cell identity (CID). The CGI is composed of a location area identity (LAI) and a cell identity (CID).

Based on the UE location information reported when accessing through a TN, the location verification network element executes user location verification in a scenario of access through an NTN.

Specifically, the example of the disclosure provides a method for processing information. The method may include at least the following.

S1: in a process that the UE accesses a network through an NTN, a first network element (location verification network element) returns an indication to the UE for requesting the UE to use the TN for access.

S2: according to the indication from the first network element, the UE initiates an access request through a TN, and the TN selects a second network element and reports the location information (CGI selected by the UE in the TN) to the second network element.

S3: the second network element transmits the location information to the first network element.

S4: the first network element executes location verification according to the location information, that is, determines whether the UE is allowed to access a PLMN where the first network element is located through the NTN at a current location.

With an AMF1 as a first core network device and an AMF2 as a second core network device as an example, the method for processing information provided in the example of the disclosure is described below with reference to a flowchart. The method can be applied to a scenario where the UE accesses a same PLMN through the TN and the NTN.

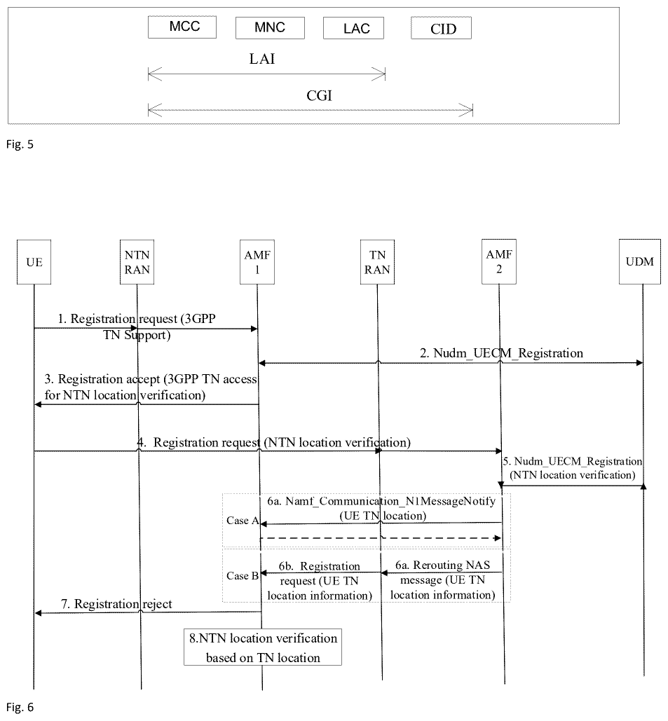

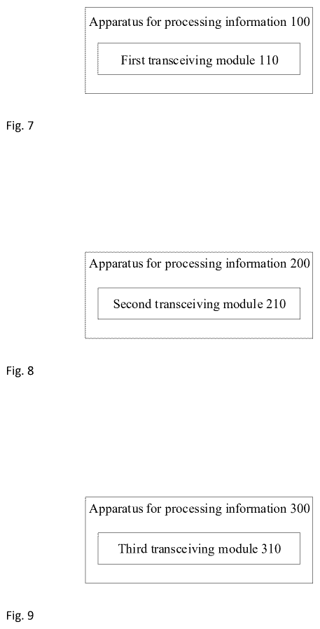

As shown in FIG. 6, the method for processing information may include any of the following steps 1-8.

1. UE initiates a registration request when accessing through an NTN, and a registration request message corresponding to the registration request includes a capability of the UE to support access through a TN. An NTN RAN selects an AMF1 according to information such as SUCI and transmits the registration request to the AMF1.

2. The AMF1 processes the registration request message from the UE and initiates registration to UDM. As part of a UE registration process, the AMF1 transmits an AMF1 identifier and an NTN access type used by the UE to the UDM for storage.

3. The AMF1 receives a registration request from the UE through the NTN and returns a registration success response to the UE. A response message includes indication information (that is, location verification indicating information in the above examples). The indication information indicates that NTN location verification is required, and the UE is requested to perform access through a TN access network.

4. According to the indication information, the UE initiates a registration request message through the TN access network. The registration request carries information for indicating that a registration process is configured for NTN location verification. A TN RAN selects an AMF2 according to information such as SUCI, and reports cell information corresponding to a cell selected by the UE to the AMF2. The cell information includes location information.

5. According to the indication information carried in the registration request, the AMF2 is informed that the process is a location obtaining process for NTN location verification. The AMF2 initiates a request to the UDM. The request includes the indication information. The UDM transmits AMF1 identifier information stored in step 2 to the AMF2 according to the indication information.

6. The step 6 may include the following step 6a or step 6b.

6a. The AMF2 initiates a notification message to the AMF1 according to the AMF1 identifier information, and transmits UE location information obtained in step 4 to the AMF1.

6b. The AMF2 transmits a rerouting message to the TN RAN. The rerouting message includes the AMF1 identifier information. The TN RAN transmits a registration request to the AMF1 according to the AMF1 identifier information. The request message includes the UE location information.

7. After the AMF1 obtains the UE location information, correspondingly, in case A (that is, the UE location information is transmitted from the AMF2 to the AMF1), the AMF2 may return a registration reject message to the UE. In case B (that is, the UE location information is transmitted from the TN RAN to the AMF1), the AMF1 may return a registration reject message of access by the UE through a TN to the UE.

8. The AMF1 executes a location verification procedure in the circumstance of NTN access based on the UE location information, that is, determines whether the UE is allowed to access a PLMN where the AMF1 is located at the location, and if the UE is allowed to access the PLMN where the AMF1 is located at the location, the process ends. If the UE is not allowed to access the PLMN where the AMF1 is located at the location, the AMF1 initiates a de-registration process to the UE and indicates that the UE is not allowed to access the PLMN at the current location.

FIG. 7 is a structural diagram of an apparatus for processing information according to an example. As shown in FIG. 7, the apparatus for processing information 100 is applied to a first core network device. The apparatus 100 for processing information may include a first transceiving module 110.

The first transceiving module 110 is configured to receive a TN cell identifier transmitted by a second core network device or a TN access network device, and where the TN cell identifier: indicates a location of UE, identification information of a cell used by the UE when accessing through a TN, and is configured for the first core network device to perform location verification on the UE when accessing through an NTN.

In an example, the first core network device is selected by an NTN access network device when accessing by the UE through the NTN; and the second core network device is selected by the TN access network device when accessing by the UE through the TN.

In an example, the first transceiving module 110 is further configured to transmit, in a case that a registration request message carrying the TN cell identifier and sent by the TN access network device is received, a registration reject message to deny the UE access through a TN access network to the UE.

In an example, the apparatus 100 further includes a processing module (not shown) configured to verify, based on location information of the UE corresponding to the TN cell identifier, whether the UE is allowed to access a public land mobile network (PLMN) selected by the UE at the location of the UE.

The first transceiving module 110 is further configured to transmit a de-registration message of access through the NTN to the UE when a verification result of the processing module indicates that the UE is not allowed to access the PLMN selected by the UE at the location of the UE.

In an example, the first transceiving module 110 is further configured to return a registration response message to the UE according to a first registration request message sent by the UE through the NTN access, where the registration response message comprises location verification indicating information in the circumstance of the NTN access, and the location verification indicating information is configured to request the location information of the UE when accessing through the TN.

In an example, the first transceiving module 110 is further configured to transmit an identifier of the first core network device to a third core network device, where the identifier of the first core network device is configured to be stored in the third core network device.

FIG. 8 is a structural diagram of an apparatus for processing information according to an example. As shown in FIG. 8, the apparatus for processing information 200 is applied to a second core network device. The apparatus 200 for processing information may include a second transceiving module 210.

The second transceiving module 210 is configured to receive a second registration request message sent by UE through a TN access network device, where the second registration request message includes location verification indicating information in the circumstance of NTN access.

The second transceiving module 210 is further configured to obtain, from a third core network device, an identifier of a first core network device selected by the UE when accessing through the NTN according to the location verification indicating information in the circumstance of the NTN access. The identifier of the first core network device is configured for the second core network device or the TN access network device to transmit a TN cell identifier used by the UE to the first core network device. The TN cell identifier is configured for the first core network device to perform location verification on the UE when accessing through the NTN.

In an example, the second registration request message further includes the TN cell identifier used by the UE.

In an example, the second transceiving module 210 is further configured to transmit the TN cell identifier to the first core network device according to the identifier of the first core network device.

In an example, the second transceiving module 210 is further configured to transmit the identifier of the first core network device to the TN access network device.

In an example, the second transceiving module 210 is further configured to transmit the TN cell identifier to the TN access network device.

In an example, the second transceiving module 210 is further configured to transmit, after the TN cell identifier is transmitted to the first core network device, a registration reject message to deny the UE access through a TN access network to the UE.

FIG. 9 is a structural diagram of an apparatus for processing information according to an example. As shown in FIG. 9, the apparatus for processing information 300 is applied to a TN access network device. The apparatus 300 for processing information may include a third transceiving module 310.

The third transceiving module 310 is configured to receive, from a second core network device, an identifier of a first core network device selected by UE when accessing through an NTN.

The third transceiving module 310 is further configured to transmit a TN cell identifier used by the UE to the first core network device according to the identifier of the first core network device. The TN cell identifier is configured for the first core network device to perform location verification on the UE when accessing through the NTN.

In an example, the third transceiving module 310 is further configured to receive the TN cell identifier from the second core network device.

In an example, the TN cell identifier is carried in a registration request message sent to the first core network device.

It should be noted that those skilled in the art can understand that the apparatus for processing information according to the examples of the disclosure may be executed independently or may be executed together with some apparatuses in the examples of the disclosure or some apparatuses in related art.

With respect to the apparatus for processing information in the examples, particular ways in which the various modules execute operations have been described in detail in the examples relating to the method, and will not be described in detail here.

A communication device is provided in an example of the disclosure. The communication device includes: a processor, and a memory configured to store a processor-executable instruction. Where the processor is configured to implement the method for processing information according to any one of the examples of the disclosure when running the executable instruction.

In an example, the communication device may include, but is not limited to, at least one of UE, an access network device, or a core network device. Here, the access network device may include an NTN access network device and a TN access network device. The core network device may include an AMF, UDM, etc.

The memory may include various types of storage media. The storage media are non-transitory computer-readable storage media that may continue memorizing information stored after the user equipment is powered off.

The processor may be connected to the memory through a bus, etc. and configured to read an executable program stored on the memory, for example, at least one of the methods shown in FIGS. 2 to 6.

A non-transitory computer-readable storage medium is further provided in an example of the disclosure. The non-transitory computer-readable storage medium stores a computer-executable program, where the computer-executable program implements the method for processing information according to any one of the examples of the disclosure when executed by a processor, for example, at least one of the methods shown in FIGS. 2 to 6.

For the apparatus for processing information or the storage medium in the examples, specific ways in which each module executes operations have been described in detail in the examples relating to the methods, which will not be described in detail here.

In a first aspect of the examples of the disclosure, a method for processing information is provided. The method is performed by a first core network device and includes: receiving a terrestrial network (TN) cell identifier transmitted by a second core network device or a TN access network device, and where the TN cell identifier: indicates a location of user equipment (UE), identification information of a cell used by the UE when accessing through a TN, and is configured for the first core network device to perform location verification on the UE when accessing through a non-terrestrial network (NTN).

In a second aspect of the examples of the disclosure, a method for processing information is provided. The method is performed by a second core network device and includes: receiving a second registration request message sent by UE through a terrestrial network (TN) access network device, where the second registration request message includes location verification indicating information in the circumstance of NTN access; and obtaining, from a third core network device, an identifier of a first core network device selected by the UE when accessing through the NTN according to the location verification indicating information in the circumstance of the NTN access, where the identifier of the first core network device is configured for the second core network device or the TN access network device to transmit a TN cell identifier used by the UE to the first core network device, and the TN cell identifier is configured for the first core network device to perform location verification on the UE when accessing through the NTN.

In a third aspect of the examples of the disclosure, a method for processing information is provided. The method is performed by a TN access network device and includes: receiving, from a second core network device, an identifier of a first core network device selected by UE when accessing through an NTN; and transmitting a TN cell identifier used by the UE to the first core network device according to the identifier of the first core network device, where the TN cell identifier is configured for the first core network device to perform location verification on the UE when accessing through the NTN.

In a fourth aspect of the examples of the disclosure, an apparatus for processing information is provided. The apparatus is applied to a first core network device and includes: a first transceiving module configured to receive a TN cell identifier transmitted by a second core network device or a TN access network device, and where the TN cell identifier: indicates a location of UE, identification information of a cell used by the UE when accessing through a TN, and is configured for the first core network device to perform location verification on the UE when accessing through an NTN.

In a fifth aspect of the examples of the disclosure, an apparatus for processing information is provided. The apparatus is applied to a second core network device and includes: a second transceiving module configured to receive a second registration request message sent by UE through a TN access network device, where the second registration request message includes location verification indicating information in the circumstance of NTN access; and the second transceiving module is further configured to obtain, from a third core network device, an identifier of a first core network device selected by the UE when accessing through the NTN according to the location verification indicating information in the circumstance of the NTN access, where the identifier of the first core network device is configured for the second core network device or the TN access network device to transmit a TN cell identifier used by the UE to the first core network device, and the TN cell identifier is configured for the first core network device to perform location verification on the UE when accessing through the NTN.

In a sixth aspect of the examples of the disclosure, an apparatus for processing information is provided. The apparatus is applied to a TN access network device and includes: a third transceiving module configured to receive, from a second core network device, an identifier of a first core network device selected by UE when accessing through an NTN, where the third transceiving module is further configured to transmit a TN cell identifier used by the UE to the first core network device according to the identifier of the first core network device, and the TN cell identifier is configured for the first core network device to perform location verification on the UE when accessing through the NTN.

In a seventh aspect of the examples of the disclosure, a communication device is provided. The communication device includes: a processor, and a memory configured to store processor-executable instructions, where the processor is configured to implement the method for processing information in the first aspect, the second aspect or the third aspect when running the executable instructions.

In an eighth aspect of the examples of the disclosure, a computer storage medium is provided. The computer storage medium stores a computer-executable program. The executable program when executed by a processor, implements the method for processing information in the first aspect, the second aspect or the third aspect.

According to technical solutions provided in the examples of the disclosure, the TN cell identifier transmitted by the second core network device or the TN access network device is received by the first core network device. The TN cell identifier is configured for the first core network device to perform location verification on the UE when accessing through the NTN. Due to limitation of coverage of a TN cell, the TN cell identifier, as identification information of a cell used by the UE when accessing through the TN, can accurately represent the location of the UE. Thus, compared with a tracking area identity (TAI) of the NTN representing the location of the UE, the TN cell identifier has higher reliability, and can improve reliability of the location verification of the UE in an NTN access scenario.

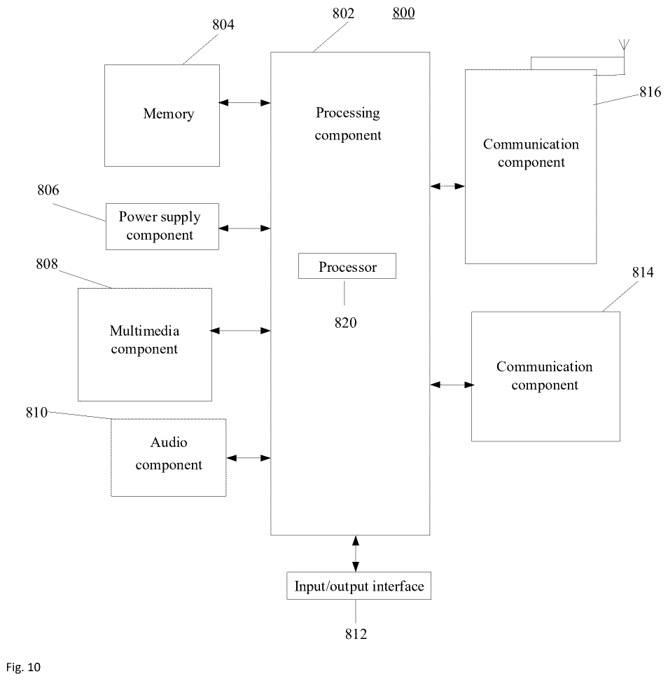

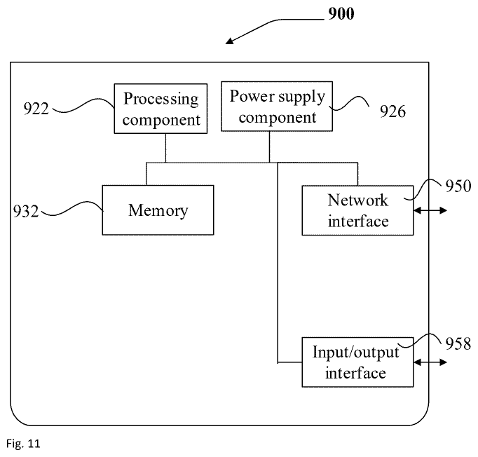

FIG. 10 is a block diagram of user equipment 800 shown according to an example. For example, the user equipment 800 may be a mobile phone, a computer, digital broadcast user equipment, a message transceiving device, a gaming console, a tablet device, a medical device, a fitness device, a personal digital assistant, etc.

With reference to FIG. 10, the user equipment 800 may include one or more of a processing component 802, a memory 804, a power supply component 806, a multimedia component 808, an audio component 810, an input/output (I/O) interface 812, a sensor component 814, and a communication component 816.

The processing component 802 generally controls an overall operation of the user equipment 800, for example, operations associated with display, phone calls, data communication, camera operations, and recording operations. The processing component 802 may include one or more processors 820 to execute an instruction, so as to complete all or some of the steps of the method above. Moreover, the processing component 802 may include one or more modules to facilitate interaction between the processing component 802 and other components. For example, the processing component 802 may include a multimedia module, so as to facilitate the interaction between the multimedia component 808 and the processing component 802.

The memory 804 is configured to store various types of data, so as to support the operations at the user equipment 800. Instances of these data include instructions for any application or method configured to be operated on the user equipment 800, contact data, phonebook data, messages, pictures, videos, etc. The memory 804 may be implemented through any type of volatile or non-volatile storage devices or their combinations, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, and an optical disk.

The power supply component 806 supplies power to the various components of the user equipment 800. The power supply component 806 may include a power supply management system, one or more power supplies, and other components associated with power generation, management, and distribution for the user equipment 800.

The multimedia component 808 includes a screen that provides an output interface between the user equipment 800 and a user. In some examples, the screen may include a liquid crystal display (LCD) and a touch panel (TP). If including the touch panel, the screen may be implemented as a touch screen, so as to receive an input signal from the user. The touch panel includes one or more touch sensors, so as to sense touches, swipes, and gestures on the touch panel. The touch sensor may sense a boundary of a touch or swipe action and measure time and pressure associated with a touch or swipe operation. In some examples, the multimedia component 808 includes a front-facing camera and/or a rear-facing camera. When the user equipment 800 is in an operational mode, for example, a photographing mode or a video mode, the front-facing camera and/or the rear-facing camera may receive external multimedia data. Each of the front-facing camera and the rear-facing camera may be a fixed optical lens system or have a focal length and an optical zoom capability.

The audio component 810 is configured to output and/or input audio signals. For example, the audio component 810 includes a microphone (MIC) configured to receive an external audio signal when the user equipment 800 is in the operational mode, for example, a calling mode, a recording mode, and a speech recognition mode. The received audio signal may be further stored in the memory 804 or transmitted via the communication component 816. In some examples, the audio component 810 further includes a speaker for outputting an audio signal.

An I/O interface 812 provides an interface between the processing component 802 and a peripheral interface module. The above peripheral interface module may be a keyboard, a click wheel, a button, etc. These buttons may include, but are not limited to, a home button, a volume button, a start button, and a lock button.

The sensor component 814 includes one or more sensors configured to provide state assessments of various aspects for the user equipment 800. For example, the sensor component 814 may detect an on/off state of the device 800 and relative locating of the components. For example, the components are a display and a keypad of the user equipment 800. The sensor component 814 may also detect a change in position of the user equipment 800 or one component of the user equipment 800, the presence or absence of contact between the user and the user equipment 800, orientation or acceleration/deceleration of the user equipment 800, and a change in temperature of the user equipment 800. The sensor component 814 may include a proximity sensor configured to detect presence of nearby objects in absence of any physical contact. The sensor component 814 may further include a light sensor, such as a complementary metal-oxide-semiconductor transistor (CMOS) or charge coupled device (CCD) image sensor configured to be used in imaging application. In some examples, the sensor component 814 may further include an acceleration sensor, a gyroscope sensor, a magnetic sensor, a pressure sensor, or a temperature sensor.

The communication component 816 is configured to facilitate communication between the user equipment 800 and other devices in a wired or radio manner. The user equipment 800 may access a radio network based on a communication standard, for example, wireless fidelity (Wi-Fi), 2G or 3G, or their combination. In an example, the communication component 816 receives a broadcast signal or broadcast related information from an external broadcast management system via a broadcast channel. In an example, the communication component 816 further includes a near field communication (NFC) module, so as to facilitate short-range communication. For example, the NFC module may be implemented based on a radio frequency identification (RFID) technology, an infrared data association (IrDA) technology, an ultra wide band (UWB) technology, a Bluetooth (BT) technology, etc.

In an example, the user equipment 800 may be configured to execute the method above by being implemented by one or more application-specific integrated circuits (ASICs), digital signal processors (DSPs), digital signal processing devices (DSPDs), programmable logic devices (PLDs), field programmable gate array (FPGAs), controllers, microcontrollers, microprocessors, etc.

In an example, a non-transitory computer-readable storage medium is further provided and includes instructions, for example, a memory 804 including instructions. The instructions are executable by a processor 820 of the user equipment 800, so as to complete the method above. For example, the non-transitory computer-readable storage medium may be an ROM, a random access memory (RAM), a compact disk read-only memory (CD-ROM), a magnetic tape, a floppy disk, an optical data storage device, etc.

As shown in FIG. 11, a structure of a communication device is shown according to an example of the disclosure. For example, the communication device 900 may be provided as a network side device. With reference to FIG. 11, the communication device 900 includes a processing component 922, and further includes one or more processors (not shown) and memory resources represented by a memory 932 and configured to store an instruction executable by the processing component 922, for example, an application. The application stored in the memory 932 may include one or more modules, each of which corresponds to a set of instructions. Further, the processing component 922 is configured to execute the instructions to implement any of the methods described above as configured for the first core network device, any of the methods described above as configured for the second core network device, or any of the methods described above as configured for the NTN access network device.

The communication device 900 may further include a power supply component 926 configured to execute power supply management of the communication device 900, a wired or radio network interface 950 configured to connect the communication device 900 to a network, and an input/output (I/O) interface 958. The communication device 900 may operate based on an operating system stored in the memory 932, such as Windows Server™, Mac OS X™, Unix™, Linux™, and FreeBSD™.

Other embodiments of the disclosure will readily occur to those skilled in the art upon consideration of the description and practice the disclosure disclosed here. The disclosure is intended to cover any variations, uses or adaptive changes of the disclosure, which follow the general principles of the disclosure and include common general knowledge or conventional technical means in the art that are not disclosed in the disclosure. The description and the examples are merely deemed illustrative, and the true scope and spirit of the disclosure are indicated by the following claims.

It should be understood that the disclosure is not limited to precise structures that have been described above and shown in the accompanying drawings, and various modifications and changes can be made without departing from the scope of the disclosure. The scope of the disclosure is limited merely by the appended claims.

1. A method for processing information, performed by a first core network device, comprising:
receiving a terrestrial network (TN) cell identifier transmitted by a second core network device or a TN access network device, and wherein the TN cell identifier:
indicates a location of user equipment (UE), identification information of a cell used by the UE when accessing through a TN, and
is configured for the first core network device to perform location verification on the UE when accessing through a non-terrestrial network (NTN).

2. The method according to claim 1, wherein
the first core network device is selected by an NTN access network device when accessing by the UE through the NTN; and
the second core network device is selected by the TN access network device when accessing by the UE through the TN.

3. The method according to claim 1, further comprising:
transmitting, in a case that a registration request message carrying the TN cell identifier and sent by the TN access network device, a registration reject message to deny the UE access through a TN access network.

4. The method according to claim 1, wherein the location verification on the UE in when accessing through the NTN comprises:
verifying, based on location information of the UE corresponding to the TN cell identifier, whether the UE is allowed to access a public land mobile network (PLMN) selected by the UE at the location of the UE; and
transmitting, in a case that the UE is not allowed to access the PLMN selected by the UE at the location of the UE, a de-registration message of access through the NTN to the UE.

5. The method according to claim 1, further comprising:
returning a registration response message to the UE according to a first registration request message sent by the UE through NTN access, wherein the registration response message comprises location verification indicating information in the circumstance of the NTN access, and the location verification indicating information is configured to request the location information of the UE when accessing through the TN.

6. The method according to claim 5, further comprising:
transmitting an identifier of the first core network device to a third core network device, wherein the identifier of the first core network device is configured to be stored in the third core network device.

7. A method for processing information, performed by a second core network device, comprising:
receiving a second registration request message sent by user equipment (UE) through a terrestrial network (TN) access network device, wherein the second registration request message comprises location verification indicating information in the circumstance of non-terrestrial network (NTN) access; and
obtaining, from a third core network device, an identifier of a first core network device selected by the UE when accessing through the NTN according to the location verification indicating information in the circumstance of the NTN access, wherein the identifier of the first core network device is configured for the second core network device or the TN access network device to transmit a TN cell identifier used by the UE to the first core network device, and the TN cell identifier is configured for the first core network device to perform location verification on the UE when accessing through the NTN.

8. The method according to claim 7, wherein the second registration request message further comprises the TN cell identifier used by the UE.

9. The method according to claim 7, further comprising:
transmitting the TN cell identifier to the first core network device according to the identifier of the first core network device.

10. The method according to claim 7, further comprising:
transmitting the identifier of the first core network device to the TN access network device.

11. The method according to claim 10, further comprising:
transmitting the TN cell identifier to the TN access network device.

12. The method according to claim 9, further comprising:
transmitting, after the TN cell identifier is sent to the first core network device, a registration reject message to deny the UE access through a TN access network to the UE.

13. A method for processing information, performed by a terrestrial network (TN) access network device, comprising:
receiving, from a second core network device, an identifier of a first core network device selected by user equipment (UE) when accessing through a non-terrestrial network (NTN); and
transmitting a TN cell identifier used by the UE to the first core network device according to the identifier of the first core network device, wherein the TN cell identifier is configured for the first core network device to perform location verification on the UE when accessing through the NTN.

14. The method according to claim 13, further comprising:
receiving the TN cell identifier from the second core network device.

15. The method according to claim 13, wherein the TN cell identifier is carried in a registration request message sent to the first core network device.

16-18. (canceled)

19. A communication device, comprising:
one or more processors; and
a memory configured to store processor-executable instructions, wherein
the one or more processors are collectively configured to implement the method for processing information according to claim 1 when running the executable instructions.

20. A non-transitory computer-readable storage medium, storing a computer-executable program, wherein the executable program when executed by a processor, implements the method for processing information according to any one of claim 1.

21. A communication device, comprising:
one or more processors; and
a memory configured to store processor-executable instructions, wherein
the one or more processors are collectively configured to implement the method for processing information according to claim 7 when running the executable instructions.

22. A communication device, comprising:
one or more processors; and
a memory configured to store processor-executable instructions, wherein
the one or more processors are collectively configured to implement the method for processing information according to claim 13 when running the executable instructions.

23. A non-transitory computer-readable storage medium, storing a computer-executable program, wherein the executable program when executed by a processor, implements the method for processing information according to claim 7.
